(19) United States
(12) Patent Application Publication
(10) Pub. No.: US 2011/0154388 A1
(43) Pub. Date: Jun. 23, 2011

(54) DIGITAL BROADCAST RECEIVER

(76) Inventor: Hidemitsu SHIMAMOTO, Tokyo (JP)

(21) Appl. No.: 12/833,820

(22) Filed: Jul. 9, 2010

(30) Foreign Application Priority Data
Dec. 18, 2009 (JP) 2009-287300

(51) Int. Cl. H04N 7/167

(52) U.S. Cl. 725/31

(57) ABSTRACT

A digital broadcast receiver has a first module that uses a conditional access card to receive a digital broadcast signal protected by scrambling, and a second module that receives a digital broadcast signal not protected by scrambling. Each module decodes its own received signal, and the second module selects and outputs one of the decoded signals. Each module includes its own controller. The controller in the first module executes application programs downloaded with the scrambled digital broadcast signal. The controller in the second module executes embedded application programs. Software troubleshooting is simplified because the two types of application programs run on separate controllers, and power consumption can be reduced by switching off the power of the first module when the conditional access card is not inserted.

### BACKGROUND OF THE INVENTION

1. Field of the Invention

The present invention relates to a digital broadcast receiver, more specifically to a digital broadcast receiver conforming to the OpenCable standard.

2. Description of the Related Art

In recent years, many countries have begun to migrate from analog broadcasting to digital terrestrial broadcasting. Digitization of cable broadcasting is also proceeding, and an OpenCable broadcasting specification has been introduced in the U.S.A. and Korea. The OpenCable receiver specification is described in OpenCable Host Device 2.1 Core Functional Requirements OC-SP-HOST2.1-CFR-109-090904.

The OpenCable specification describes a conditional access card, referred to as a CableCARD, a trademark, for decrypting conditional access encryption and transferring out-of-band (OOB) signals. An exemplary OpenCable receiver using a CableCARD has been disclosed in Japanese Patent Application Publication No. 2008-510352 (WO2006/016760).

In a conventional digital broadcasting receiver, the application programs, such as user interfaces and tuning programs, are all embedded, whereas an OpenCable receiver (“OpenCable” is a trademark) includes embedded OpenCable Applications Platform (OCAP) middleware for executing application programs downloaded from broadcasting stations (cable TV stations). These application programs are used only for receiving cable broadcasts, so conventional embedded programs must be used to control the receiving of terrestrial broadcast signals, digital versatile disc (DVD) signals, and other external signals.

The OpenCable specification does not specify how the downloaded application programs are to coexist with the embedded application programs. Japanese Patent Application Publication No. 2008-310553 describes a method in which both types of application programs reside on a single controller and one type of program or the other is selected according to the controller's start-up mode.

An OpenCable digital broadcast receiver must include not only an interface for the cable card, but also an out-of-band signal transmitting-receiving circuit and a cable modem conforming to the Data Over Cable Service Interface Specification (DOCSIS), but all this circuitry takes up space and consumes power. Another problem is that if the downloaded application programs and embedded application programs share the same tuner and other hardware resources, the software becomes complex, and if both types of applications operate on the same control device, then when problems occur, troubleshooting takes extra time.

### SUMMARY OF THE INVENTION

One object of the invention is to provide a digital broadcast receiver with a simple system configuration.

Another object of the present invention is to provide a digital broadcast receiver with reduced power consumption.

Still another object is to provide a more convenient digital broadcast receiver.

A digital broadcast receiver according to the invention has a first module and a second module.

The first module includes a first receiver for receiving a digital broadcast signal protected by conditional access, such as a cable broadcast signal. The first module also includes a first interface for connection with a conditional access card operable to decrypt the digital broadcast signal protected by conditional access, a first decoder for decoding the signal decrypted by the conditional access card, an output unit for encrypting an output of the first decoder to generate an encrypted output signal, and a first controller for controlling the above components, downloading an application program received together with the digital broadcast signal, and executing the application program.

The second module includes an input unit for receiving and decrypting the encrypted output signal to generate a first output signal, a second receiver for receiving a digital broadcast signal not protected by conditional access, a second decoder for decoding this digital broadcast signal to generate a second output signal, a display processor for selecting, processing, and outputting the first or second output signal as selected by the user, and a second controller for controlling the input unit, second receiver, second decoder, and display processor.

The second controller may also execute application programs, but these are embedded application programs.

The first module may include a power source that is switched off by the second controller when the conditional access card is not inserted.

The second controller may prevent the display processor from selecting the signal received from the first module when the conditional access card is not inserted.

When the conditional access card is not inserted, the second module may receive a cable broadcast signal and the second controller may construct a map in a memory indicating cable broadcast channels not protected by conditional access.

The second controller preferably controls all power-on/off switching and audio volume adjustment operations, controls channel selection and tuning operations by the second receiver, and processes the relevant commands input by the user. When the conditional access card is inserted and the display processor selects the first output signal, the first controller preferably controls channel selection and tuning operations by the first receiver, and processes the relevant commands input by the user.

The first module may also include an on-screen display processor. If the first receiver receives high-priority emergency warning information, the on-screen display processor overlays the warning information on the output of the first decoder and the first controller instructs the second controller to have the display processor select the signal received by the input unit. If the first receiver receives low-priority emergency warning information, the first controller sends the emergency warning information to the second controller through a communication link and the second controller processes the emergency warning information.

The digital broadcast receiver has a simple modular structure that facilitates efficient manufacturing.

Power consumption can be reduced by switching the power of the first module off when the conditional access card is not inserted.

The digital broadcast receiver is convenient because downloaded application programs operate on one controller and embedded application programs operate on another controller, so that when software problems occur, troubleshooting is simplified.

### BRIEF DESCRIPTION OF THE DRAWINGS

In the attached drawings:

FIG. 1 is a block diagram illustrating a digital broadcast receiver in a first embodiment of the invention;

FIG. 2 is a block diagram illustrating a portion of the digital broadcast receiver in a second embodiment of the invention;

FIG. 3 is a block diagram illustrating a portion of the digital broadcast receiver in a third embodiment of the invention;

FIG. 4 is a block diagram illustrating a portion of the digital broadcast receiver in a fourth embodiment of the invention; and

FIG. 5 is a block diagram illustrating a portion of the digital broadcast receiver in a fifth embodiment of the invention.

### DETAILED DESCRIPTION OF THE INVENTION

Embodiments of the invention will now be described with reference to the attached drawings, in which like elements are indicated by like reference characters.

### First Embodiment

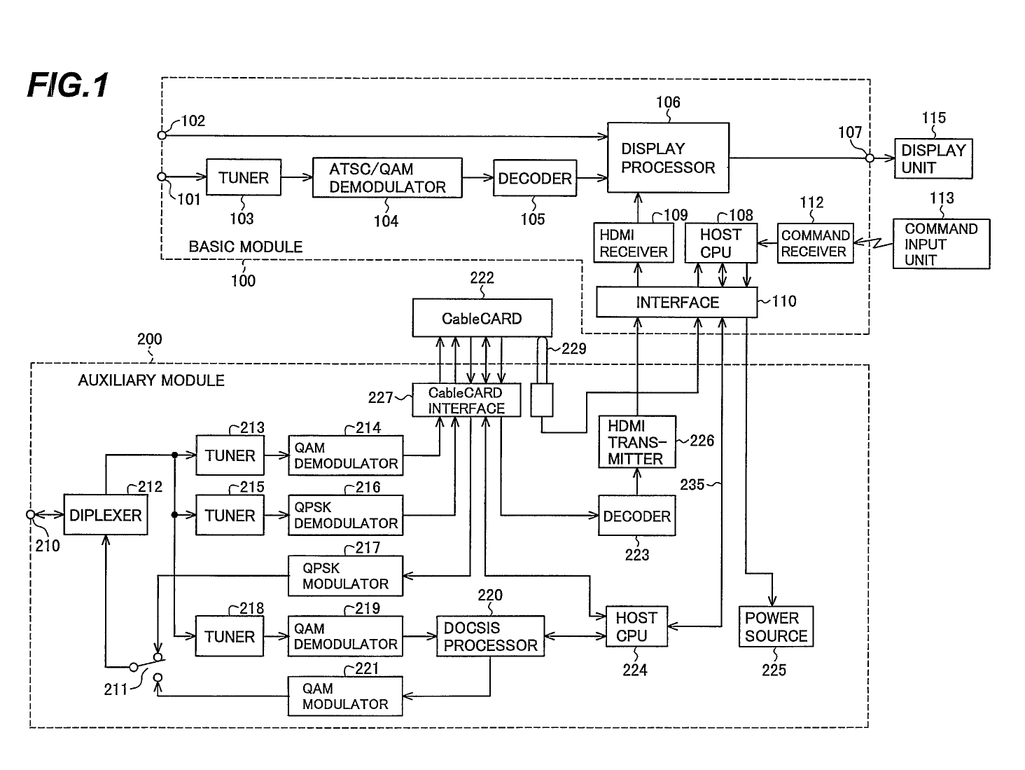

Referring to FIG. 1, the digital broadcast receiver in the first embodiment has a basic module 100 for receiving digital terrestrial broadcasts and the like, and an auxiliary module 200 for receiving cable broadcasts. The basic module 100 includes a pair of input terminals 101, 102, a tuner 103, an Advanced Television Standards Committee/quadrature amplitude modulation (ATSC/QAM) demodulator 104, a decoder 105, a display processor 106, a host central processor (CPU) 108, a high-definition multimedia interface (HDMI) receiver 109, an interface 110, and a command receiver 112.

The command receiver 112 receives signals from a command input unit 113 such as, for example, a keyboard or a remote control. The user uses the command input unit 113 to enter operating commands, which the command receiver 112 sends to the host CPU 108.

The auxiliary module 200 includes an input-output terminal 210, a switch 211, a diplexer 212, tuners 213, 215, 218, a QAM demodulator 214, a quadrature phase shift keying (QPSK) demodulator 216, a QPSK modulator 217, a QAM demodulator 219, a DOCSIS processor 220, a QAM modulator 221, a decoder 223, a host CPU 224, a power source 225, an HDMI transmitter 226, and a CableCARD interface 227.

A CableCARD 222 is detachably inserted into the auxiliary module 200 as a conditional access card. When inserted into the auxiliary module 200, the CableCARD 222 is connected to QAM demodulator 214, QPSK demodulator 216, QPSK modulator 217, decoder 223, and host CPU 224 through the CableCARD interface 227.

The basic module 100 is integrally mounted in the digital broadcast receiver. The auxiliary module 200 is detachably mounted in the digital broadcast receiver. When mounted in the digital broadcast receiver, the auxiliary module 200 is electrically connected to the basic module 100 through the interface 110 as shown in FIG. 1, but this connection is detachable.

Signals pass in both directions through the input-output terminal 210 of the auxiliary module 200. The diplexer 212 separates the incoming signals from the outgoing signals. The incoming signals are received cable broadcast signals, including audio and video signals that the diplexer 212 passes to tuner 213, GOB signals that the diplexer 212 passes to tuner 215, and DOCSIS signals that the diplexer 212 passes to tuner 218.

Tuner 213 tunes to a video signal channel. QAM demodulator 214 demodulates the tuned video channel signal to a bitstream and passes the bitstream to the CableCARD 222. This bitstream has been encrypted (scrambled) for conditional access. The CableCARD 222 decrypts (descrambles) the bitstream.

The CableCARD 222 passes the descrambled bitstream, which is still encrypted by the Data Encryption Standard (DES) algorithm, to decoder 223. Decoder 223 decrypts the DES encryption and decodes the decrypted bitstream to reproduce the baseband video signal.

An audio signal is similarly reproduced, but for simplicity, only the reproduction of a video signal will be described below.

Tuner 215 is tuned to receive an GOB signal. QPSK demodulator 216 demodulates the GOB signal into a datastream and passes the datastream to the CableCARD 222. From the GOB signal, the CableCARD 222 obtains a decryption signal (key) for decrypting the conditional access decryption, or information describing currently broadcast programs. GOB signal content is specified by a Society of Cable Telecommunications Engineers standard (SCTE 55). The CableCARD 222 communicates with host CPU 224 through the CableCARD interface 227.

Through the CableCARD interface 227, signals pass from QAM demodulator 214 and QPSK demodulator 216 to the CableCARD 222 and from the CableCARD 222 to the QPSK modulator 217 and decoder 223.

When the digital broadcast receiver sends a datastream to the broadcast station, such as a datastream requesting video-on-demand or a unique device identifier for releasing the conditional access encryption, the CableCARD interface 227 passes the datastream to the diplexer 212 through QPSK modulator 217 and the switch 211. The diplexer 212 restricts this outgoing signal to a specified frequency band, differing from the frequency bands of the incoming signals, so that the incoming and outgoing signals do not interfere with each other.

Tuner 218 is tuned to receive a DOCSIS signal. QAM demodulator 219 demodulates the DOCSIS signal to a datastream, and the DOCSIS processor 220 decodes the datastream. The OpenCable specification specifies that GOB signals are transmitted by the DOCSIS system using the DOCSIS Set-Top Gateway (DSG) system. Because a broadcast station may choose either the GOB system or the DOCSIS system, although the digital broadcast receiver includes both GOB and DOCSIS signal circuits, only one of these two signal circuits is actually used.

When the digital broadcast receiver sends DOCSIS signals to the broadcast station, the DOCSIS signals are modulated by the QAM modulator 221 and pass through the switch 211 to the diplexer 212.

Host CPU 224 communicates with the CableCARD 222 through the CableCARD interface 227, determines from the signal received from the CableCARD 222 whether the GOB system or the DOCSIS system is used by the cable system in which the digital broadcast receiver is installed, selects the GOB signal circuit or the DOCSIS signal circuit, and controls the switch 211 accordingly. When the GOB signal circuit is used, GOB signals are passed from the QPSK modulator 217 to the diplexer 212; when the DOCSIS signal circuit is used, DOCSIS signals are passed from the QAM modulator 221 to the diplexer 212.

Host CPU 224 controls the circuits in the auxiliary module 200, including the tuners 213, 215, 218, demodulators 214, 216, 219, modulators 217, 221, DOCSIS processor 220, decoder 223, HDMI transmitter 226, and CableCARD interface 227, and controls the CableCARD 222. Host CPU 224 includes embedded OCAP middleware and uses a boot memory and working memory (not shown) to operate autonomously. Host CPU 224 also receives application programs sent as part of the datastreams described above, and executes the application programs on the OCAP middleware to implement different services such as Electronic Program Guide (EPG) and video-on-demand services. Accordingly, host CPU 224 may obtain viewing and listening application programs transmitted by a broadcasting station by downloading them via the broadcast signal.

The power source 225 in the auxiliary module 200 supplies power to host CPU 224 and the circuits it controls in the auxiliary module 200. This power source 225 is turned on and off independently of the operation of the power source (not shown) for the basic module 100 and the other parts of the digital broadcast receiver.

Input terminal 101 in the basic module 100 normally receives terrestrial broadcast signals, but may be connected to receive cable broadcast signals as well. The basic module 100 can process cable broadcast signals successfully if they are not protected by conditional access. Tuner 103 is tuned to a desired video signal channel. The ATSC/QAM demodulator 104 demodulates the tuned video channel signal to a bitstream. Decoder 105 decodes the demodulated bitstream.

Input terminal 102 receives baseband video signals other than broadcast signals, such as video signals reproduced from a DVD. Signals input from input terminal 102 or output from the decoder 105 enter the display processor 106.

Host CPU 108 controls the circuits in the basic module 100, and uses a boot memory and working memory (not shown) to operate autonomously by executing predetermined embedded programs.

Tuner 103 and the ATSC/QAM demodulator 104 constitute the receiver of the basic module 100; tuners 213, 215, 218 and demodulators 214, 216, 219 constitute the receiver of the auxiliary module 200.

Signals output from the decoder 223 in the auxiliary module 200 pass to the display processor 106 through the interface 110 in the basic module 100. Under control of host CPU 108, the display processor 106 selects the signal received from the auxiliary module 200 (the first output signal), the signal received from decoder 105 (the second output signal), or the signal received from input terminal 102, performs different adjustments, produces a final output signal, and sends the final output signal to a display unit 115 through an output terminal 107. Host CPU 108 controls the selection made by the display processor 106 according to commands entered by the user using the command input unit 113.

Signals that pass from decoder 223 to the display processor 106 are encrypted for content protection, using an interface such as the High-Definition Multimedia Interface (HDMI). The HDMI transmitter 226 therefore converts the format of the video data received from decoder 223 to the HDMI format, a process that includes encryption of the video data, and sends the converted video data to the HDMI receiver 109 through the interface 110 in the basic module 100 as an encrypted output signal. The HDMI receiver 109 decrypt the encrypted output signal and restores the received HDMI video data to the original format. The HDMI transmitter 226 accordingly operates as an output unit that sends signals from the auxiliary module 200 to the basic module 100, and the HDMI receiver 109 in the basic module 100 operates as an input unit that receives signals from the auxiliary module 200.

To enable the two modules 100, 200 to cooperate, host CPU 108 communicates with host CPU 224 through a communication link 235 such as, for example, a Universal Asynchronous Receiver Transmitter (UART) link.

The auxiliary module 200 operates only when the CableCARD 222 is inserted. More specifically, when the CableCARD 222 is not inserted, the digital broadcast receiver is permitted to process only signals not protected by conditional access, and cannot use OOB signals. Only the basic module 100 can then operate. Accordingly, even if the digital broadcast receiver includes the OCAP auxiliary module 200, by not inserting the CableCARD 222 the user can choose not to use the cable broadcast receiving function temporarily, or semi-permanently.

The CableCARD interface 227 for the CableCARD 222 conforms to the Personal Computer Card (PC Card) standard, and has a pair of card detection pins 229 at each end (only one pair is shown in FIG. 1). The card detection pins 229 are pulled up to the power supply potential of the basic module 100 when the CableCARD 222 is not inserted, and fall to the ground potential when the CableCARD 222 is inserted. Host CPU 108 in the basic module 100 determines whether the CableCARD 222 is inserted by receiving a detection signal obtained from the detection pins 229. When the CableCARD 222 is not inserted into the auxiliary module 200 and the card detection pins 229 are at the power supply potential, host CPU 108 halts the operation of the auxiliary module 200 by turning off its power source 225.

When the power source 225 is turned off, if the CableCARD 222 is inserted, host CPU 108 detects that the CableCARD 222 is inserted because the card detection pins 229 fall to the ground potential, turns on the power source 225, starts up the auxiliary module 200, communicates with host CPU 224 through the communication link 235, notifies host CPU 224 of the insertion of the CableCARD 222, and allows host CPU 224 to activate the CableCARD 222.

As described above, when the CableCARD 222 is not inserted, host CPU 108 avoids unnecessary power consumption by preventing the power source 225 from supplying power to the auxiliary module 200. In addition, since host CPU 224 executes downloaded application programs and host CPU 108 executes embedded application programs, when software problems occur, troubleshooting is simplified. Moreover, the detachable mounting of the auxiliary module 200 in the digital broadcast receiver facilitates selective manufacturing of a basic digital broadcast receiver including only the basic module 100 and a multifunctional digital receiver including both the basic module 100 and the auxiliary module 200.

### Second Embodiment

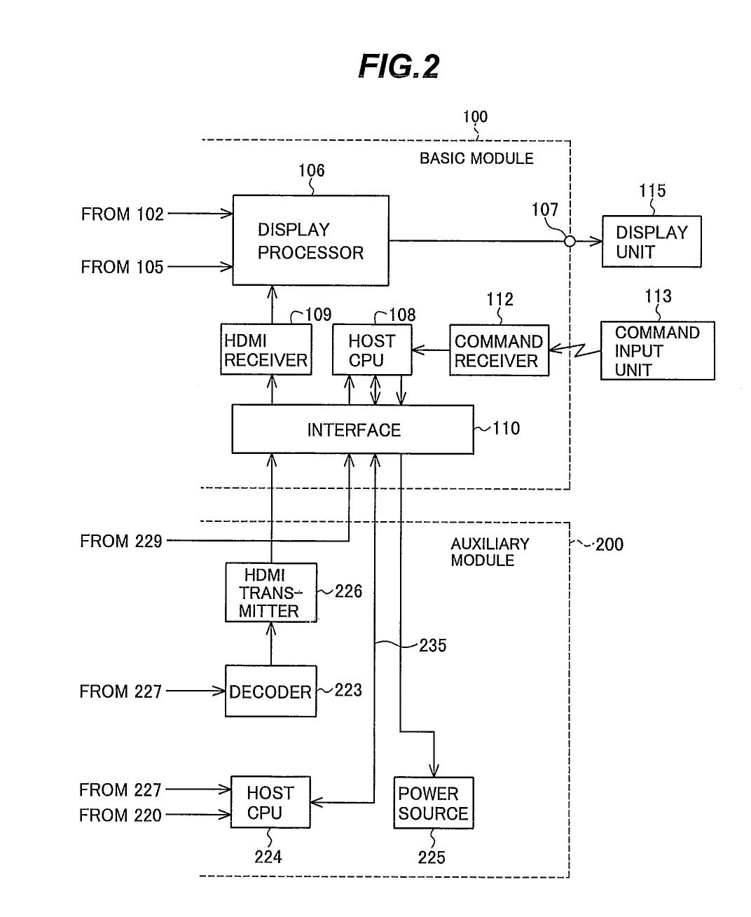

The digital broadcast receiver in the second embodiment has a generally identical configuration as the digital broadcast receiver in the first embodiment. FIG. 2 shows the display processor 106, host CPU 108, HDMI receiver 109, interface 110, and command receiver 112 in the basic module 100, the command input unit 113 and display unit 115, and the decoder 223, host CPU 224, power source 225, HDMI transmitter 226, and communication link 235 in the auxiliary module 200. The digital broadcast receiver in the second embodiment also has input terminals 101, and 102, tuners 103, 213, 215, 218, demodulators 104, 214, 216, and 219, decoder 106, input-output terminal 210, diplexer 212, modulators 217, and 221, DOCSIS processor 220, CableCARD interface 227, for connection with CableCARD 222, and card detection pins 229, which are shown in FIG. 1, but they are omitted from FIG. 2.

The second embodiment operates in substantially the same way as the first embodiment, but with the following difference.

As in the first embodiment, host CPU 108 receives a detection signal obtained from the card detection pins 229 and determines whether the CableCARD 222 is inserted.

When host CPU 108 determines that the CableCARD 222 is not inserted, since the auxiliary module 200 does not necessarily have to operate, host CPU 108 may turn off its power source 225 as in the first embodiment, or switch the auxiliary module 200 into a standby state. In this state, no signal is output from decoder 223. If the display processor 106 selects input from the auxiliary module 200 in this state and sends the selected but nonexistent signal to the display unit 115, the user may mistake the resulting blank display for a device failure. Host CPU 108 therefore allows the display processor 106 to select only the signals received from input terminal 102 and decoder 105 and prevents the display processor 106 from selecting the signal received from decoder 223. That is, host CPU 108 allows the display processor 106 to select only signals with significant display data, prevents the display of nonexistent signals, and thereby avoids confusing the user.

### Third Embodiment

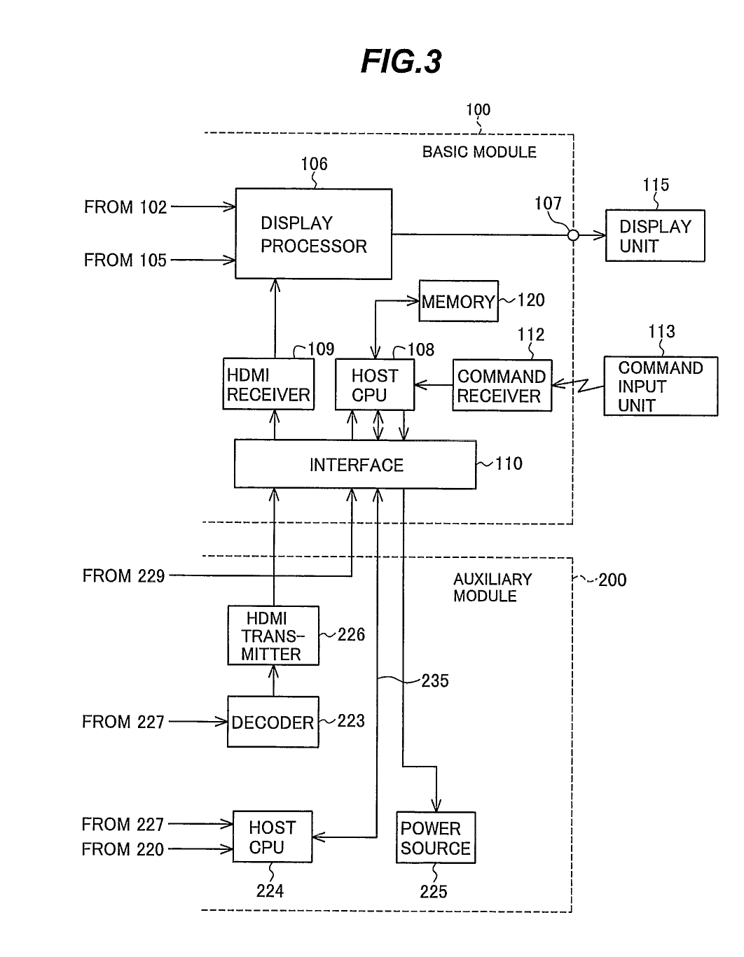

The digital broadcast receiver in the third embodiment has a generally identical configuration as the digital broadcast receiver in the first embodiment, but differs from the digital broadcast receiver in the first embodiment by adding a memory 120 for storing a channel map, and by operations described below. FIG. 3 shows the display processor 106, host CPU 108, HDMI receiver 109, interface 110, command receiver 112, and memory 120 in the basic module 100, the command input unit 113 and display unit 115, and the decoder 223, host CPU 224, power source 225, HDMI transmitter 226, and communication link 235 in the auxiliary module 200. The digital broadcast receiver in the third embodiment also has input terminals 101, and 102, tuners 103, 213, 215, 218, demodulators 104, 214, 216, and 219, decoder 106, input-output terminal 210, diplexer 212, modulators 217, and 221, DOCSIS processor 220, CableCARD interface 227, for connection with CableCARD 222, and card detection pins 229, which are shown in FIG. 1, but they are omitted from FIG. 3.

The difference between the first and third embodiments is that a channel map is created in the memory 120.

As in the first and second embodiments, host CPU 108 receives a detection signal obtained from the card detection pins 229 and determines whether the CableCARD 222 is inserted.

When host CPU 108 determines that the CableCARD 222 is not inserted, since the auxiliary module 200 does not necessarily have to operate, host CPU 108 may switch the auxiliary module 200 into a standby state or turn off its power source 225. In this state it is still possible to receive cable broadcast signals if they are not protected by conditional access. More specifically, the receiver section 103, 104 of the basic module 100 can receive these cable broadcast signals under control of host CPU 108, and the basic module 100 processes the received cable broadcast signals. To facilitate this process, host CPU 108 generates a channel map by storing information identifying receivable signal channels in the memory 120 in the basic module 100. The channel map is then used in subsequent channel tuning.

When host CPU 108 determines that the CableCARD 222 is not inserted, if the user enters a channel scanning command as part of an initial setting process, host CPU 108 uses the basic module 100 to scan all cable broadcast channels. On detecting a channel with a signal not protected by conditional access, host CPU 108 stores the relevant channel information in the memory 120. If the user later enters a tuning command such as a channel up or down command by using the command input unit 113 and command receiver 112, host CPU 108 reads the channel information stored in the memory 120 and tunes to an unprotected video signal channel.

In the third embodiment, even a user who does not have a CableCARD 222 can continue to view and listen to cable broadcasts not protected by conditional access.

### Fourth Embodiment

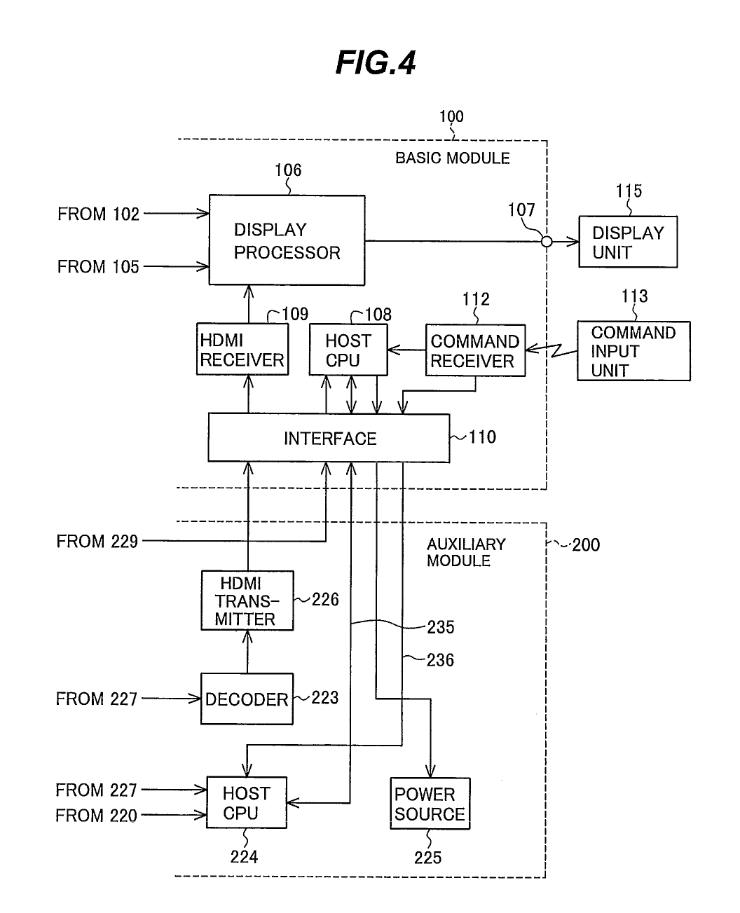

The digital broadcast receiver in the fourth embodiment has a generally identical configuration as the digital broadcast receiver in the first embodiment, but is provided with an additional communication link 236, and operations differ as described below. FIG. 4 shows the display processor 106, HDMI receiver 109, interface 110, command receiver 112, and host CPU 108 in the basic module 100, the command input unit 113 and display unit 115, and the decoder 223, host CPU 224, power source 225, HDMI transmitter 226, and communication link 235 in the auxiliary module 200. The digital broadcast receiver in the fourth embodiment also has input terminals 101, and 102, tuners 103, 213, 215, 218, demodulators 104, 214, 216, and 219, decoder 106, input-output terminal 210, diplexer 212, modulators 217, and 221, DOCSIS processor 220, CableCARD interface 227, for connection with CableCARD 222, and card detection pins 229, which are shown in FIG. 1, but they are omitted from FIG. 4.

The fourth embodiment operates in substantially the same way as the first embodiment, but with the following difference.

In the fourth embodiment, the command receiver 112 passes commands received from the command input unit 113 directly to the host CPU 108 in the basic module 100 and, through the interface 110, directly, i.e., without passing through the CPU 108, to the host CPU 224 in the auxiliary module 200. For this passage of the commands, the additional communication link 236 is used. The two host CPUs 108, 224 are also interconnected through the interface 110 and communication link 235, however, and through this route, the two host CPUs 108, 224 exchange and share information indicating the signal selected by the user.

As in the first to third embodiments, the host CPU 108 in the basic module 100 receives a detection signal obtained from the card detection pins 229 and determines whether the CableCARD 222 is inserted.

When host CPU 108 determines that the CableCARD 222 is not inserted, host CPU 108 controls the selection made by the display processor 106 according to commands entered by the user using the command input unit 113 and command receiver 112. The display processor 106 selects the signal received from input terminal 102 or the signal received from decoder 105, and produces an output signal. In addition, host CPU 108 processes all power-on/off switching operations, channel selection operations such as channel up/down operations, and audio volume adjustment operations, including mute control, in the digital broadcast receiver. Host CPU 108 also processes all key operations, such as number key operations and up-down-right-left arrow key operations on menus, including broadcast program selection menus and menus for various other functions.

Even when host CPU 108 detects that the CableCARD 222 is inserted, if a command entered by the user instructs host CPU 108 to have the display processor 106 select the signal received from input terminal 102 or decoder 105, host CPU 108 processes all the operations noted above.

When host CPU 108 detects that the CableCARD 222 is inserted and the user command has the display processor 106 select the signal received from decoder 223, however, host CPU 224 executes a downloaded application program to process tuning operations such as, for example, channel up/down operations, and key operations such as, for example, the menu operations noted above. Host CPU 108 continues to process power-on/off switching operations and audio volume adjustment operations, including mute control.

In short, host CPU 108 always knows whether the CableCARD 222 is inserted or not and which input the user has selected, and this information determines its processing duties. Host CPU 224 learns whether the CableCARD 222 is inserted or not and which input the user has selected by communicating with host CPU 108 through the interface 110 and communication link 235, and performs the processing that is not performed by host CPU 108.

This arrangement enables host CPU 108 to maintain consistent power control and audio volume control, while at the same time enabling channel selection operations and menu operations to be processed by the appropriate host CPU: the host CPU 224 in the auxiliary module 200 when the CableCARD 222 is inserted and the user selects the signal from decoder 223 in the auxiliary module 200; the host CPU 108 in the basic module 100 in other cases. All commands and operations input by the user can therefore be appropriately executed.

In a variation of the fourth embodiment, commands entered by the user via the command input unit 113 and command receiver 112 are sent only to host CPU 108 and are not sent directly to host CPU 224 as described above. Host CPU 108 receives the commands and then sends them through the interface 110 and communication link 235 to host CPU 224, adding information indicating whether the CableCARD 222 is inserted and which input the user has selected.

### Fifth Embodiment

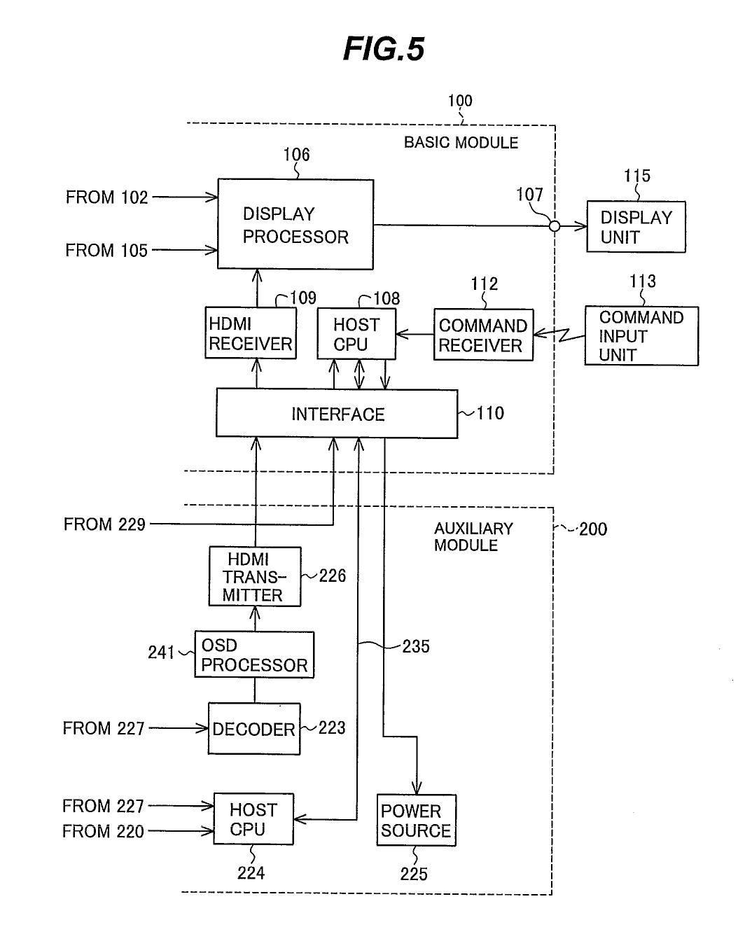

The digital broadcast receiver in the fifth embodiment has a generally identical configuration as the digital broadcast receiver in the first embodiment, but differs from the digital broadcast receiver in the first embodiment by including an additional on-screen display (OSD) processor, and by operations described below. FIG. 5 shows the display processor 106, HDMI receiver 109, interface 110, command receiver 112, and host CPU 108 in the basic module 100, the command input unit 113 and display unit 115, and the decoder 223, host CPU 224, power source 225, HDMI transmitter 226, communication link 235, and OSD processor 241 in the auxiliary module 200. The digital broadcast receiver in the fifth embodiment also has input terminals 101, and 102, tuners 103, 213, 215, 218, demodulators 104, 214, 216, and 219, decoder 106, input-output terminal 210, diplexer 212, modulators 217, and 221, DOCSIS processor 220, CableCARD interface 227, for connection with CableCARD 222, and card detection pins 229, which are shown in FIG. 1, but they are omitted from FIG. 5.

The fifth embodiment operates in substantially the same way as the first embodiment, but with the following difference. In the fifth embodiment, the OSD processor 241 performs processing for displaying characters indicating emergency warning information overlaid on video data. The display processor 106 can also perform similar overlay display processing.

As in the first to fourth embodiments, the host CPU 108 in the basic module 100 receives a detection signal obtained from the card detection pins 229 and determines whether the CableCARD 222 is inserted.

When the CableCARD 222 is inserted and the auxiliary module 200 operates, the auxiliary module 200 may receive emergency warning information. Emergency warning information display may be mandated by the government, as in the United States, for example, where the emergency warning information is referred to as an Emergency Alert System (EAS) message.

When the display processor 106 is using the signal received from the auxiliary module 200 to produce an output signal, if the auxiliary module 200 receives emergency warning information and host CPU 224 detects that an EAS message is received, the auxiliary module 200 receives and processes the EAS signal. Depending on the content of the EAS message, the OSD processor 241 may overlay characters indicating the message on the video data, or tune in a specified broadcast channel that broadcasts the EAS message and relevant detailed information.

When the display processor 106 is using the signal received from input terminal 102 or decoder 105 to produce the final output signal, if the auxiliary module 200 receives emergency warning information and host CPU 224 detects that an EAS message is received, the auxiliary module 200 receives and processes the EAS signal. Host CPU 224 determines the priority of the EAS message packet. If the priority exceeds a predetermined value, for example, ‘eleven’, the auxiliary module 200 and the OSD processor 241 perform all the operations noted above, and host CPU 224 sends a request for forced signal switching to host CPU 108 through the communication link 235. On receiving the request, host CPU 108 controls the display processor 106 so as to pass the broadcast channel signal with the EAS message and relevant detailed information received from the auxiliary module 200 to output terminal 107.

If host CPU 224 determines that the priority of the message packet is lower than the predetermined value of, for example, ‘eleven’, the OSD processor 241 does not display the message but sends the message packet to host CPU 108 through the communication link 235. Host CPU 108 restores the received message to its original format, thereby recovering the message before conversion. The display processor 106 displays the message overlaid on the video data currently being viewed.

As described above, in the fifth embodiment, when the auxiliary module 200 receives an EAS message, it may be processed by either host CPU 224 or host CPU 108, depending on the priority of the EAS message. Regardless of which input signal the user has selected and which video data are being displayed, when an EAS message is received, host CPU 224 or host CPU 108 can display the EAS message as appropriate for its priority.

When the CableCARD 222 is not inserted, if the basic module 100 receives emergency warning information and host CPU 108 detects that an EAS message is received, host CPU 108 determines the priority of the EAS message packet. Depending on the priority, the display processor 106 may overlay characters indicating the message on the video data, or tune in a specified broadcast channel that broadcasts the EAS message and relevant detailed information.

The first to fifth embodiments can be combined. For example, the first embodiment, which turns off the power source 225 in the auxiliary module 200 when the CableCARD 222 is not inserted, can be combined with the digital broadcast receivers in the second to fourth embodiments. Accordingly, the power source 225 is shown in the auxiliary module 200 in FIGS. 2 to 5 as well as in FIG. 1. In the second to fifth embodiments, however, the auxiliary module 200 does not necessarily have to include a power source 225; the power source (not shown) in the basic module 100 may supply power to the circuits in the auxiliary module 200.

The second embodiment, in which the display processor 106 in the basic module 100 cannot select the signal output from the auxiliary module 200 when the CableCARD 222 is not inserted, may be combined with the digital broadcast receivers in the first, third, fourth, and fifth embodiments.

The third embodiment, in which the basic module 100 receives cable broadcast signals not protected by conditional access and creates a channel map thereof, may be similarly combined with the digital broadcast receivers in the first, second, fourth, and fifth embodiments.

The fourth embodiment, in which the command receiver 112 passes commands directly to the host CPU 224 in the auxiliary module 200 and operations are processed by either host CPU 108 or host CPU 224, as appropriate, may be combined with the digital broadcast receivers in the first, second, third, and fifth embodiments.

The emergency warning information processing described in the fifth embodiment may be added to the digital broadcast receivers in the first to fourth embodiments.

Those skilled in the art will recognize that further variations are possible within the scope of the invention, which is defined in the appended claims.

What is claimed is:

1. A digital broadcast receiver comprising:
a first module that includes
a first receiver for receiving a digital broadcast signal protected by conditional access,
a first interface for insertion of a conditional access card operable to decrypt the digital broadcast signal protected by conditional access,
a first decoder for decoding the signal decrypted by the conditional access card,
an output unit for encrypting an output of the first decoder to generate an encrypted output signal, and
a first controller for controlling the first receiver, the first interface, the first decoder, and the output unit, downloading an application program received together with the digital broadcast signal, and executing the application program; and
a second module that includes,
an input unit for receiving the encrypted output signal from the first module and decrypting the encrypted output signal to generate a first output signal,
a second receiver for receiving a digital broadcast signal not protected by conditional access,
a second decoder for decoding the digital broadcast signal received by the second receiver to generate a second output signal,
a display processor for selecting, processing, and outputting the first output signal or the second output signal according to a user selection, and
a second controller for controlling the second receiver, the second decoder, the input unit, and the display processor.

2. The digital broadcast receiver of claim 1, wherein the digital broadcast signal protected by conditional access is a cable broadcast signal.

3. The digital broadcast receiver of claim 1, wherein the second controller executes embedded application programs.

4. The digital broadcast receiver of claim 1, wherein:
the first module also includes a power source for supplying power to the first receiver, the first interface, the first decoder, the output unit, and the first controller; and
the second controller determines whether or not the conditional access card is inserted and prevents the power source in the first module from supplying power to the first receiver, the first interface, the first decoder, the output unit, and the first controller when the conditional access card is not inserted.

5. The digital broadcast receiver of claim 1, wherein the second controller determines whether or not the conditional access card is inserted and prevents the display processor from selecting the first output signal when the conditional access card is not inserted.

6. The digital broadcast receiver of claim 1, further comprising a memory, wherein when the second controller determines whether the conditional access card is inserted, and if the conditional access card is not inserted, the second receiver receives cable broadcast signals and the second controller makes a channel map in the memory, the channel map indicating cable broadcast signals not protected by conditional access.

7. The digital broadcast receiver of claim 1, further comprising a command receiver for receiving commands input by the user and supplying the commands to both the first controller and the second controller, wherein:
the second controller controls power-on/off switching and audio volume adjustment operations and determines whether or not the conditional access card is inserted;
when the second controller determines that the conditional access card is not inserted, the second controller also processes all the commands input by the user and controls all tuning and channel selection operations;
when the second controller determines that the conditional access card is inserted and the display processor selects the second output signal, the second controller controls the tuning and channel selection operations in the second receiver and processes related commands input by the user; and
when the second controller determines that the conditional access card is inserted and the display processor selects the first output signal, the first controller controls tuning and channel selection operations in the first receiver and processes related commands input by the user.

8. The digital broadcast receiver of claim 7, further comprising a communication link for communicably interconnecting the first controller and the second controller, wherein the first controller receives the related commands input by the user from the second controller via the communication link.

9. The digital broadcast receiver of claim 7, wherein the command receiver supplies the commands input by the user directly to the first controller.

10. The digital broadcast receiver of claim 1, further comprising a communication link for communicably interconnecting the first controller and the second controller, wherein:
the first module also includes an on-screen display processor inserted between the first decoder and the output unit, for overlaying text on an output of the first decoder under control of the first controller;
the second controller determines whether or not the conditional access card is inserted;
when the second controller determines that the conditional access card is inserted, if the first receiver in the first module receives emergency warning information of a priority exceeding a prescribed value, the first controller causes the on-screen display processor to overlay text indicating the emergency warning information on the output of the first decoder and instructs the second controller to have the display processor select the first output signal; and
when the second controller determines that the conditional access card is inserted, if the first receiver in the first module receives emergency warning information of a priority lower than the prescribed value, the first controller sends the emergency warning information to the second controller through the communication link and the second controller processes the emergency warning information.

11. The digital broadcast receiver of claim 10, wherein the emergency warning information is an Emergency Alert System message.

12. The digital broadcast receiver of claim 1, wherein the first module is detachably mounted in the digital broadcast receiver, the second module is integrally mounted in the digital broadcast receiver, and the second module has a second interface by which the first module is detachably connected to the second module.
